(19) United States
(12) Patent Application Publication
(10) Pub. No.: US 2024/0112268 A1
(43) Pub. Date: Apr. 4, 2024

(54) METHOD FOR IDENTIFYING AND INITIATING REVERSIBLE SUBROGATION CLAIMS

(71) Applicant: Second Look, Inc., Hauppauge, NY (US)

(72) Inventor: Christopher TIDBALL, Cocoa, FL (US)

(21) Appl. No.: 18/374,875

(22) Filed: Sep. 29, 2023

Related U.S. Application Data
(60) Provisional application No. 63/411,401, filed on Sep. 29, 2022.

(51) Int. Cl. G06Q 40/08

(52) U.S. Cl. CPC G06Q 40/08

(57) ABSTRACT

A computer-implemented method for identifying and initiating reversible subrogation claims. A subrogation demand for an insurance claim is received and analyzed to determine a type and a jurisdiction of the insurance claims. A subrogation rule is then ascertained based on the type and jurisdiction of the insurance claim, and a determination of whether the subrogation demand is proper or improper is made. If the subrogation demand has been fulfilled and found to be improper, a recommendation to initiate recovery of all or a portion of a settlement amount of the subrogation demand is generated.

### CROSS-REFERENCE TO RELATED APPLICATIONS

This application claims priority to U.S. Provisional Application No. 63/411,401, filed on Sep. 29, 2022, which is incorporated herein by reference in its entirety.

### FIELD OF THE INVENTION

This disclosure generally relates to the field of insurance subrogation payments, and more particularly, to identifying and initiating claims to reverse improperly settled subrogation payments.

### BACKGROUND

When an insured person suffers a covered loss, an insurer may pay costs to the insured person and pursue subrogation from another party involved in the loss. For example, if an insured vehicle is involved in a collision and suffers a loss, the insurer may compensate the vehicle owner, i.e., insured, according to an insurance agreement. If, for example, the vehicle owner was not at fault in the collision, the insurer may pursue damages from another party, such as the insurer of the party who was at fault in the collision. An insurance agreement may include an obligation of the insured to assign the insured's claim against a party at fault to the insurer, who may then collect on the claim on the insured's behalf, i.e., subrogation. For example, if an insured's car is destroyed in an auto accident caused by a third-party, the insured's insurance company may pay the insured for the value of the car, and separately seek to recover the amount paid from the third-party's insurance company or the third-party if uninsured.

Analytics and algorithms have been developed to identify subrogation cases, which is often all that is needed, particularly for claims of low complexity. However, subrogation payments are sometimes made in situations where the payment was not actually owed according to statutes in individual jurisdictions. These improper payments may be reversed through legal means, but they are often never identified, so the improper payments are never reversed. For example, a van owned by a plumbing or construction company in New York rear-ends a car. The car owner's insurance carrier pays the injured party in the car personal injury protection and then subrogates the claim to the plumbing company's insurance carrier because the gross vehicle weight (GVW) is over 6,500 pounds per a tag check. However, a further check of the claim discovers that the unladen weight of the vehicle was only 5,200 pounds. According to current New York statutes, when vehicles involved in an accident are “covered,” they cannot sue each other for losses covered or that should be covered by personal injury protection, except when one of the vehicles involved in the accident weighs more than 6,500 pounds. Upon discovering that the van weights less than the 6,500-pound limit, such a claim would have been improperly paid and could be recoverable by the plumbing company's insurance carrier (i.e., from the car owner's insurance carrier).

A primary challenge to identifying and initiating the subrogation payment reversal is analyzing a large amount of data to find subrogation payments that may be candidates for reversal. A further challenge lies in the broad range of statutes in each jurisdiction that govern subrogation payments, and their ever-changing nature.

Accordingly, systems and methods to properly evaluate subrogated claims based on the relevant statutes, and recover claims paid based on incorrectly assigned fault are desirable.

### BRIEF SUMMARY

The present disclosure relates to efficient and cost-effective systems and computational methods for identifying and initiating the reversal of improper subrogation payments. Such systems and methods may be implemented on a computer system and may involve data transmitted over the internet, including cloud technologies or servers. Once reversible subrogation candidates are identified, a process to reverse the subrogation payment may be initiated.

Accordingly, the present disclosure provides a method for identifying reversible subrogation claims. The method generally comprises receiving a list of subrogation demands, wherein the list includes at least one subrogation demand for an insurance claim; determining, by analysis of the insurance claim, a type of the insurance claim and a jurisdiction of the insurance claim; determining a subrogation rule based on the type of the insurance claim and the jurisdiction of the insurance claim; determining if the subrogation demand has been fulfilled; and providing an indication of a proper or improper subrogation demand, or fulfillment thereof, based on an analysis of the subrogation rule.

When the subrogation demand was fulfilled and is improper, the method may further generate a recommendation to initiate recovery of the insurance claim and optionally, may initiate recovery of the insurance claim.

The insurance claim may comprise any of a claim against one or more of a health insurance, a worker compensation insurance, a liability insurance, a homeowner's insurance, a property casualty insurance, a motorized vehicle insurance, or a disability care insurance.

The methods may be implemented as software executable by a processor. Moreover, the software may be provided as part of a system, such as a system comprising a server having a processor, a non-transitory computer-readable storage medium, and instructions stored on the non-transitory computer-readable storage medium for execution of the method by the processor.

### DESCRIPTION OF THE DRAWINGS

It is to be understood that both the foregoing summary and the following drawings and detailed description may be exemplary and are not restrictive of the embodiments of the invention as claimed. Certain details may be set forth to provide a better understanding of various features, aspects, and advantages of the invention. However, one skilled in the art will understand that these features, aspects, and advantages may be practiced without these details. In other instances, well-known structures, methods, and/or processes associated with methods of practicing the various features, aspects, and advantages may not be shown or described in detail to avoid unnecessarily obscuring descriptions of other details of the invention.

The inventions described in the present disclosure may be better understood by reference to the accompanying drawing sheets, in which:

FIG. 1 depicts a flow chart of a computer-implemented method for identifying and initiating reversible subrogation claims;

FIG. 2 illustrates a system for identifying and initiating reversible subrogation claims in accordance with certain aspects of the present disclosure; and

FIGS. 3-6 depict a flow chart of a computer-implemented method for identifying and initiating reversible subrogation claims for a variety of insurance claim types.

### Abbreviations and Definitions

Unless otherwise defined, all terms used herein, inclusive of technical and scientific terms, have a meaning as commonly understood by one of ordinary skill in an art to which this disclosure belongs. As such, terms, such as those defined in commonly used dictionaries, should be interpreted as having a meaning that is consistent with their meaning in a context of a relevant art and should not be interpreted in an idealized or overly formal sense unless expressly so defined herein.

The term “claim” in relation to an insurance policy should be understood to mean notice to an insurer that under the terms of a policy, a loss may be covered. Claims are typically received directly from the insured or from a representative of the insurance company (e.g., an insurance agent).

Subrogation is an equitable doctrine that allows one party to replace another party when it comes to a legal right. The term “subrogation,” as used herein, may be understood to mean the substitution of one person or group by another in respect of a debt or insurance claim, accompanied by the transfer of any associated rights and duties.

As used herein, “personal injury protection” or “PIP” refers to no-fault insurance, which helps cover expenses like medical bills, lost wages, funeral costs, etc. after a car accident, no matter who is at fault. Personal injury protection insurance generally does not cover property damage, the other drivers' injuries in a collision, injuries from an accident while committing a crime, or injuries in an accident while the driver received payment for driving.

Note that various terminology used herein may imply direct or indirect, full or partial, temporary or permanent, action or inaction. For example, when an element is referred to as being “on,” “connected,” or “coupled” to another element, then the element may be directly on, connected, or coupled to the other element or intervening elements may be present, including indirect or direct variants. In contrast, when an element is referred to as being “directly connected” or “directly coupled” to another element, there may be no intervening elements present.

Furthermore, when this disclosure states that something is “based on” something else, then such statement refers to a basis which may be inclusive of one or more other things as well. In other words, unless expressly indicated otherwise, as used herein “based on” inclusively means “based at least in part on” or “based at least partially on.”

As used herein, the term “and/or” includes any and all combinations of one or more of the associated listed items. Likewise, as used in the following detailed description, the term “or” is intended to mean an inclusive “or” rather than an exclusive “or.” That is, unless specified otherwise, or clear from context, “X employs A or B” is intended to mean any of the natural inclusive permutations. Thus, if X employs A; X employs B; or X employs both A and B, then “X employs A or B” is satisfied under any of the foregoing instances.

The terminology used herein is for the purpose of describing particular examples only and is not intended to be limiting. As used herein, the singular forms “a,” “an,” and “the” may be intended to include the plural forms as well, unless the context clearly indicates otherwise. As example, “a” subrogation rule may comprise one or more subrogation rules, “an” insurance claim or “the” subrogation demand may comprise one or more insurance claims or subrogation demands, respectively, and “a” module may comprise one or more modules, and the like.

The terms “comprises,” “comprising,” “including,” “having,” and “characterized by,” may be inclusive and therefore specify the presence of stated features, elements, steps, integers, operations, and/or components, but do not preclude the presence or addition of one or more other features, integers, steps, operations, elements, components, and/or groups thereof. Although these open-ended terms may be to be understood as a non-restrictive term used to describe and claim various aspects set forth herein, in certain aspects, the term may alternatively be understood to instead be a more limiting and restrictive term, such as “consisting of” or “consisting essentially of.” Thus, for any given embodiment reciting components, elements, features, integers, operations, and/or process steps, described herein also specifically includes embodiments consisting of, or consisting essentially of, such recited components, elements, features, integers, operations, and/or process steps. In the case of “consisting of” the alternative embodiment excludes any additional components, elements, features, integers, operations, and/or process steps, while in the case of “consisting essentially of,” any additional components, elements, features, integers, operations, and/or process steps that materially affect the basic and novel characteristics may be excluded from such an embodiment, but any components, elements, features, integers, operations, and/or process steps that do not materially affect the basic and novel characteristics may be included in the embodiment.

Any method steps, processes, and operations described herein may not be construed as necessarily requiring their performance in the particular order discussed or illustrated, unless specifically identified as an order of performance. It is also to be understood that additional or alternative steps may be employed, unless otherwise indicated.

In addition, features described with respect to certain example embodiments may be combined in or with various other example embodiments in any permutational or combinatory manner. Different aspects or elements of example embodiments, as disclosed herein, may be combined in a similar manner. The term “combination,” “combinatory,” or “combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included may be combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

Aspects of the present disclosure may be described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, may be implemented by computer readable program instructions. The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, may be implemented by special purpose hardware-based systems that perform the specified functions or acts or carry out combinations of special purpose hardware and computer instructions.

Words such as “then,” “next,” etc. are not intended to limit the order of the steps; these words may be simply used to guide the reader through the description of the methods. Although process flow diagrams may describe the operations as a sequential process, many of the operations may be performed in parallel or concurrently. In addition, the order of the operations may be re-arranged. A process may correspond to a method, a function, a procedure, a subroutine, a subprogram, etc. When a process corresponds to a function, its termination may correspond to a return of the function to the calling function or the main function.

### DETAILED DESCRIPTION

This disclosure generally provides methods for identifying and initiating reversible subrogation claims and software systems that implement such methods. Conventionally, subrogation claims are rarely, if ever, identified as reversible claims and reversed. If a subrogation claim is reversed, it is likely reversed by the party who paid the claim or otherwise had direct knowledge of the claim and the circumstances under which it was paid. As a result, many subrogation claims, which were unnecessarily paid and strong candidates for reversal of the subrogation payment, may never be identified or reversed.

Subrogation demands occur for a wide variety of insurance claims. In addition to vehicle insurance claims, subrogation demands may be made against claims in health insurance, worker compensation insurance, liability insurance, homeowners or property insurance, disability care insurance, and the like. Moreover, the rules that govern subrogation demands vary by industry and jurisdiction, e.g., state. For example, in Texas the courts have held that Amazon is not liable in instances where they do not hold title to a product. However, in California and some other states, Amazon is considered liable even when they do not hold title to a product. Building this level of sophistication into a subrogation process is ever evolving and one where utilizing a closed file audit could yield substantial missed subrogation opportunities. Moreover, methods that identify subrogation demands that have been improperly requested and/or fulfilled, i.e., paid, could provide savings and/or yield substantial recovery of improper payments.

The present disclosure provides methods and computer-implementations thereof for identifying reversible subrogation demands or payments. The methods algorithmically analyze a subrogation payment and apply a number of factors to determine if the subrogation payment is being demanded and/or has been fulfilled unnecessarily, i.e., improperly. If the subrogation payment is made improperly, the methods identify the subrogation demand as a reversible subrogation payment and a reversal of the payment may be initiated.

The methods may be applied to a number of subrogation demands or payments to identify candidates for reversal of payment, which may increase the number of payments reversed and recoup a significant amount of money that may have been paid unnecessarily or improperly. Further, the methods may identify and initiate subrogation payment reversals for subrogation demands other than those paid by or already known to a party making the subrogation payment, or others with prior knowledge of the subrogation demand and context or circumstances of the subrogation demand or insurance claim. Thus, the methods disclosed herein improve identification and initiation of reversible subrogation payments which may otherwise not be reversed because they may be applied generically to a number of subrogation claims (i.e., apply a standard subrogation rule without proper assessment of the characteristics of each insurance claim).

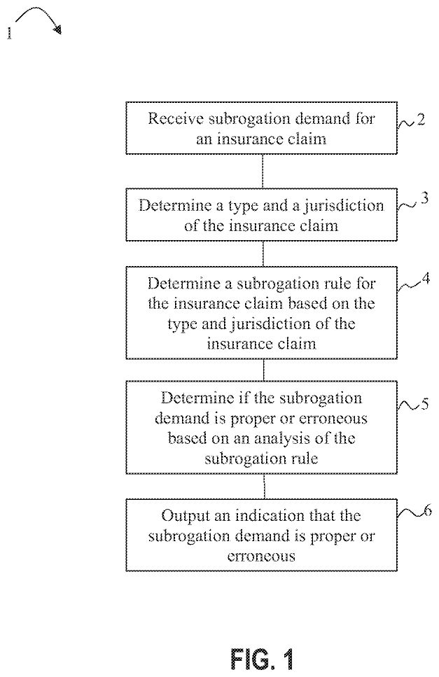

FIG. 1 depicts a flow chart of a method 1 for identifying and initiating reversal of a subrogation claim. A first step in the method comprises receiving a subrogation demand for an insurance claim, as shown at 2. The method may analyze the insurance claim to determine a type of the insurance claim and a jurisdiction of the insurance claims, as shown at 3. Exemplary jurisdictions include counties, states, regions of the country (e.g., northeast, etc.), countries, and groups of countries, such as the European Union. Exemplary types of insurance include at least health insurance, worker compensation insurance, liability insurance, homeowner's insurance, travel insurance, property and casualty insurance, property insurance, motorized vehicle insurance, disability care insurance, etc. Moreover, in each broad category of insurance, coverage may include/exclude specific elements, and thus, each broad category may include many different types of insurance.

With continued reference to FIG. 1, the method may then determine a subrogation rule based on the type of the insurance claim and the jurisdiction of the insurance claim, as shown at 4, which may be generally accomplished by accessing a table or database comprising jurisdictional statutes for subrogation of insurance claims. Comparison of the subrogation rules and the relevant characteristics of the insurance claim allow the method to validate whether the subrogation demand is proper or improper, as shown at 5. For example, have all of the facts surrounding the insurance claim been properly noted for the jurisdiction of the claim. Based on the results of this last comparison, the method may provide an output message or indication that the subrogation demand was proper or improper, i.e., erroneous, as shown at 6. If the subrogation demand is deemed proper and has not yet been fulfilled, the method may initiate a proactive subrogation of the insurance claim, such as from a third party. If the subrogation demand is deemed improper and has been fulfilled, the method may generate a recommendation to initiate recovery of the insurance claim, and/or may initiate recovery of the insurance claim from the subrogee.

The methods for identifying and initiating reversible subrogation claims disclosed herein may be implemented as a software application. For example, the software application may comprise computer-readable instructions that, when executed by a processor, cause the processor to trigger execution of the software application, also referred to herein as a reversible subrogation assistant. The reversible subrogation assistant may comprise modules that execute various functionalities of the method. For example, the reversible subrogation assistant may comprise an input module configured to receive a subrogation demand for an insurance claim and determine, by analysis of the insurance claim, a type of the insurance claim, a jurisdiction of the insurance claim, and whether the insurance claim has been paid. The input module may receive individual subrogation demands or a list of subrogation demands.

The reversible subrogation assistant may further comprise a rules module configured to access a data store of a database comprising jurisdictional statutes for subrogation of insurance claims and determine a relevant subrogation rule for the subrogation demand based on the type of the insurance claim and the jurisdiction of the insurance claim. The reversible subrogation assistant may optionally comprise an update module configured to update the data store based on changes to the one or more subrogation rules. Such updates may be incremental, such as inclusion of new statutes as they become available or enforceable, or scheduled, such as once every week, month, quarter, and the like. These updates may be manually entered, or may be automatically retrieved and entered, such as via automated scrapping of a one or more databases or information sources of individual jurisdictions.

The reversible subrogation assistant may further yet comprise a validation module configured to determine if the subrogation demand is proper or improper based on an analysis of the relevant subrogation rule. An output module may be included that is configured to output an indication that the subrogation demand is proper or improper based on that analysis and/or may generate a recommendation to initiate recovery of the insurance claim when the subrogation demand was fulfilled and found to be improper.

The reversible subrogation assistant may further comprise a reversal module configured to automatically initiate recovery of all or a portion of a settlement payment for each subrogation demand that was fulfilled and found to be improper.

According to certain aspects, the list of subrogation demands received by the input module may comprise at least one subrogation demand that has not been fulfilled. As such, the reversible subrogation assistant may pass the unfulfilled subrogation demand through the rules and validation modules to determine if the subrogation demand is proper. Unfulfilled subrogation demands that are found to be proper may be passed to a fulfillment module of the reversible subrogation assistant, which is configured to automatically initiate collection of all or a portion of a settlement payment of the subrogation demand from a third party.

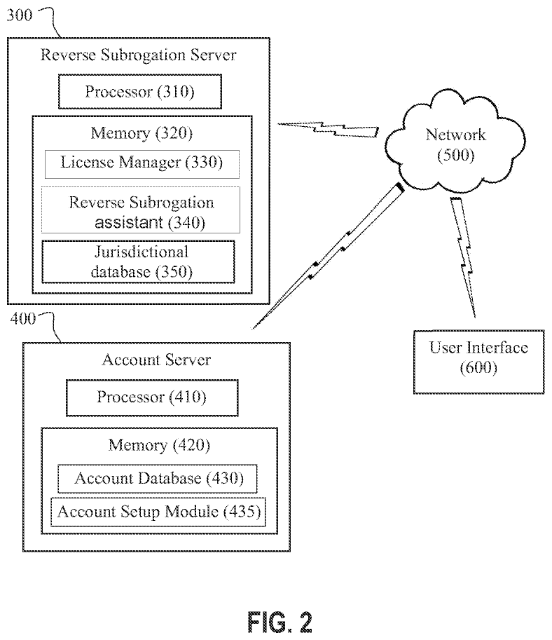

With reference to FIG. 2, the software application may be included as part of a larger system. For example, the software application (e.g., reversible subrogation assistant 340) may be part of, or executable on, a system including a reverse subrogation server 300, an account server 400, and a user interface 600, all accessible over a network 500. The software application can be presented over any one or more communications network(s) 500 (e.g., public or private) that provide access to the internet. Exemplary networks include at least wide-area-networks (e.g., WANs, cellular data networks, satellite data networks, fiber-optic networks, and/or other information networks capable of enabling communications over large distances), local-area-networks (e.g., LANs, private gaming networks), file sharing networks, social networks, etc.

Multiple users can be connected to the networks via computing devices, such as mobile phones or tablets, desktop or laptop computers, or any other device capable of communication over one or more data networks. The network 500 may have a variety of configurations, and may comprise wired, wireless, or a combination of wired and wireless communication pathways. Depending upon the configuration of the network 500, the network may comprise a wide variety of components. For example, the network 500 may include wireless communication relays or transceivers. The network 500 may also include one or more hubs or routers. The network 500 may include dedicated or public lines. For example, one or more portions of the network 500 may include the Internet, phone lines or the like. In general, the network 500 is simply adapted to permit the transmission of data or information between the reverse subrogation server 300 and user interface 600, and in some instances, the account server 400.

The reverse subrogation server 300 can host a website that provides the reverse subrogation method/software application via the internet (500) and/or other computer networks. The reverse subrogation server 300 can include other devices, servers, mechanisms, etc., that provide functionality (e.g., controls, web pages, applications, etc.) that users can use to connect to the online website and utilize website features (e.g., communications mechanisms, applications, etc.). The reverse subrogation server 300 can include a memory 320 that may store a reverse subrogation assistant 340, a jurisdictional database 350, and optionally, a license manager 330. Further, the reverse subrogation server 300 can include a processor 310 that may execute the computer-executable instructions of at least the reverse subrogation assistant 340.

The account server 400 can store data on a memory 420 for user accounts in an account database 430, and a processor 410 that may execute computer executable instructions that allow a user to create and manage an account, i.e., an account setup module 435.

The user may interact with the reverse subrogation server 300 and the account server 400 via a user interface 600 (i.e., a web site) over the network 500. The user interface 600 allows the user to create an account and select from a variety of options that define the type of insurance claim and the jurisdiction.

A user of a network-enabled device may begin an interaction with the software application by visiting a web page offered by the reverse subrogation server 300 and/or account server 400, or via a software application downloaded to the user's network-enabled device, or a combination thereof. In either case, the user may login to a pre-existing account via the account server 400 or set up a new account if the user has not registered with the account server 400 previously. Account information may be stored in the account database 430 associated with account server 400.

The user interface 600 of the software application implementing the reverse subrogation method may reside on the user's network enabled device. As such, the user may download the user interface 600 to their network-enabled device. Once the user interface of the software application is downloaded, the user may be queried about their account. If they do not yet have an account, they may set up an account that includes at least the user's email address. Additional personal/company information may be gathered at this step, such as the user's location (zip code, city and state, address, etc.) via either direct input or by location sharing from a location enabled device. The additional personal information may include other demographic information about the user or user's company affiliation. The user may also make selections of specific user preferences.

Additionally, at the account setup stage, or at any time after they have set up an account, the user may select a pricing tier of the software application that allows the user to elect to receive selected benefits from use of the software or have access to specific elements or functionalities of the software. Information about the user selected pricing tier may be stored in the account database 430 of the account server 400. The license manager 330 of the reverse subrogation server 300 may utilize data from the account database 330 to determine the tier level of a user account and allow additional or increased functionality of the user account on the reverse subrogation assistant 340 of the reverse subrogation server 300.

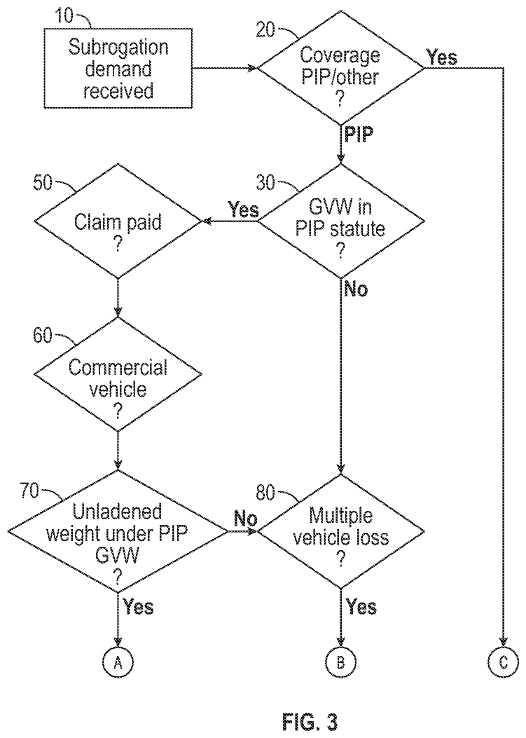

Specific examples of applying the methods disclosed herein to commonly encountered subrogation rules in vehicular insurance claims are shown in FIGS. 3-6. The method may be performed by a computer machine provided with a processing unit and a memory comprising the software application described hereinabove (e.g., FIG. 2).

With specific reference to FIG. 3, a method for identifying and initiating reversible subrogation claims according to the present disclosure may begin by receiving a subrogation demand for an insurance claim, as shown at 10. The subrogation demand for the insurance claim may be acquired from a memory of the system, e.g., computer machine, or over a network from a source such as a database, a cloud technology, or another network technology. According to certain aspects, the subrogation demand may include a party paying the amount demanded, a party receiving the amount demanded, and/or a set of circumstances or context regarding the demand or insurance claim. According to some aspects, the subrogation demand may include a state or legal jurisdiction in which an event relating to the insurance claim took place and information identifying or describing any vehicles which may be involved in the event relating to the insurance claim.

A type of the insurance claim may be determined (i.e., coverage), as shown at 20. According to some aspects, the type of the insurance claim may be a personal injury protection (PIP) claim or any other type of insurance claim. According to some aspects, the type of claim may be categorized in a binary manner as either the personal injury protection claim or another (i.e., non-personal injury protection) claim. According to some aspects, the type of claim may be information received at 10 as information regarding the subrogation demand or the insurance claim. According to some aspects, the type of claim may be acquired from a source separate from the source of information received at 10, i.e., the source of the subrogation demand or the insurance claim.

Whether a gross vehicle weight (GVW) is cited in a personal injury protection statute may be determined as shown at 30. According to some aspects, the information regarding whether a gross vehicle weight is cited in a personal injury protection statute may be information received at 10 as information regarding the subrogation demand or the insurance claim. According to some aspects, whether a gross vehicle weight is cited in a personal injury protection statute may be acquired from a source separate from the source of information received at 10, such as from the jurisdictional database 350 of FIG. 2.

At 50, it may be determined whether the insurance claim was paid. According to some aspects, the information regarding whether the insurance claim was paid at 50 may be information received at 10 or information from a source separate from the source of information received at 10. At 60, it is determined whether the vehicle involved in the insurance claim is a commercial vehicle. According to some aspects, the information regarding whether the commercial vehicle was involved in the insurance claim at 60 may be information received at 10 or information from a source separate from the source of information received at 10. At 70, it is determined whether the commercial vehicle has an unladen weight under the gross vehicle weight cited in the personal injury protection statute (i.e., subrogation rules). According to some aspects, the information regarding the unladen weight of the commercial vehicle at 70 may be information received at 10 or a source separate from the source of information received at 10, such as the jurisdictional database 350 of FIG. 2 or another database or web accessible information source.

If the commercial vehicle does not have an unladen weight under the gross vehicle weight cited in the personal injury protection statute (at 70), or alternatively, if no gross vehicle weight is cited in a personal injury protection statute (30), a determination of whether it was involved in a multiple vehicle loss may be made, as shown at 80. Such information may be received at 10 as part of the subrogation demand or may be received from a separate source.

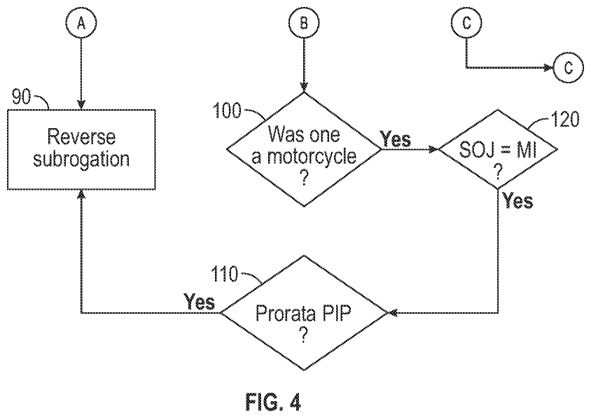

With specific reference to FIG. 4, if the commercial vehicle does have an unladen weight under the gross vehicle weight cited in the personal injury protection statute (at 70), and the insurance claim of the subrogation demand has been paid (at 50), a reverse subrogation may be advised and/or initiated at 90. Moreover, if the vehicle was involved in a multiple vehicle loss event (at 80), the method may determine if one of the vehicles was a motorcycle, as shown at 100. According to some aspects, the information regarding whether the insurance claim includes a multiple vehicle loss event at 100 may be information received at 10 or information from a source separate from the source of information received at 10.

If the insurance claim includes a multiple vehicle loss event (at 100), the jurisdictional subrogation rules may dictate whether a reverse subrogation may be advised or initiate (at 90) and whether the personal injury claim should have been prorated (at 110). That is, as shown at 120, a jurisdictional database (350 of FIG. 2) may be referenced to review jurisdictional statutes to determine the recovered amount, i.e., prorated personal injury protection claim 110), requested in the reverse subrogation (at 90).

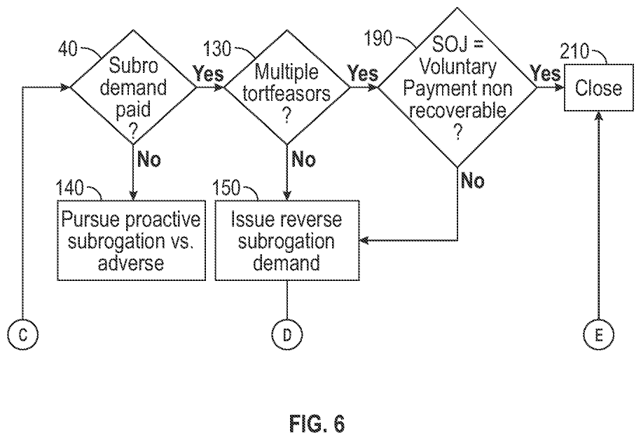

With reference to FIG. 6, the method may determine whether the subrogation demand was paid upon determining the type of insurance claim is not a personal injury protection claim, as shown at 40. According to some aspects, the information regarding whether the subrogation demand was paid at 40 may be information received at 10 or information from a source separate from the source of information received at 10.

If the subrogation demand 40 was not paid, but is proper, the method may advise and/or initiate a proactive subrogation against the adverse party, as shown at 140. If the subrogation demand 40 was paid, the method may determine whether the reverse subrogation demand involved multiple tortfeasors at 130. According to some aspects, the information regarding whether the subrogation demand involved multiple tortfeasors at 130 may be information received at 10 or information from a source separate from the source of information received at 10.

As shown at 190, upon determining the subrogation demand involved multiple tortfeasors at 130, the method may determine whether the reverse subrogation demand was under a jurisdiction in which voluntary payments are non-recoverable. According to some aspects, the information regarding whether the subrogation demand was under a jurisdiction in which voluntary payments are non-recoverable at 190 may be information received at 10 or information from a source separate from the source of information received at 10.

At 150, a reverse subrogation claim is advised and/or initiated upon determining the subrogation demand was paid at 40 and did not involve multiple tortfeasors at 130 or involved multiple tortfeasors in a jurisdiction in which voluntary payment is not recoverable at 190. However, should the method determine that the subrogation demand was paid at 40 and did not involve multiple tortfeasors at 130, and/or involved multiple tortfeasors in a jurisdiction in which voluntary payment is are recoverable at 190, the method may advise that the subrogation was proper and advise no further action, i.e., advise against a reverse subrogation, as shown at 210.

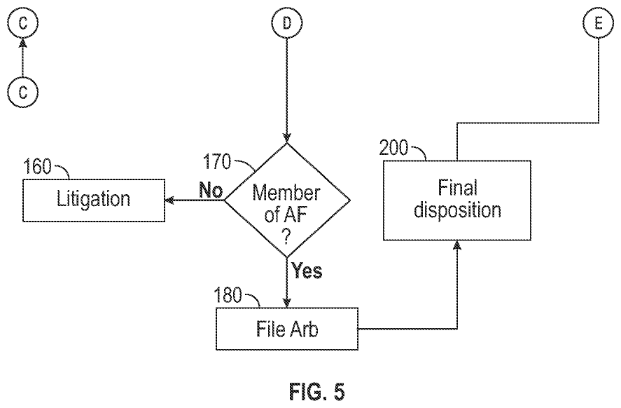

With reference to FIG. 5, when a reverse subrogation claim is advised, such as at 150 of FIG. 6, the method may determine whether the subrogation demand was issued by a member of Arbitration Forums, as shown at 170 (follow line D). In this case, if the subrogation demand was issued by a member of Arbitration Forums, the method may advise and/or initiate a filing for arbitration as shown at 180, which the method may follow and/or document through arbitration to final disposition, as shown at 210. However, if the subrogation demand was not issued by a member of Arbitration Forums, the method may advise and/or initiate a litigation as shown at 160.

As described, the present disclosure provides methods for identifying improperly paid or settled subrogation demands. Aspects of the disclosure include a computer-implemented method executed on one or more processors, servers, and/or associated transceivers that comprises: receiving electronic data comprising a list including at least one subrogation demand for which a settlement payment has been made, each subrogation demand in the list being for an insurance claim; determining, by analysis of the insurance claim of each of the subrogation demands in the list, a type of the insurance claim and a jurisdiction of the insurance claim; determining, by accessing data stored on a database, a relevant subrogation rule for the insurance claim of each of the subrogation demands in the list based on the type of the insurance claim and the jurisdiction of the insurance claim, wherein the data stored on the database comprises jurisdictional statutes for subrogation of insurance claims; determining if each of the subrogation demands in the list was proper or improper based on an analysis of the relevant subrogation rule; and outputting, for each of the subrogation demands in the list, an indication that the subrogation demand was proper or improper based on the analysis of the relevant subrogation rule.

The list of subrogation demands may include information for each subrogation demand, such as a subrogee identity, the type of the insurance claim, the jurisdiction of the insurance claim, a loss amount, and a settlement payment amount. The list may also include at least one subrogation demand that has not been fulfilled by a third party. For each of these unfulfilled subrogation demands that are not personal injury protection claims, the method may output an indication that the subrogation demand was proper or improper based on the analysis of the relevant subrogation rule.

In some implementations, the method may comprise, for at least one of the subrogation demands indicated to be improper and having been fulfilled, automatically initiating recovery of all or a portion of the settlement payment amount of the subrogation demand from the subrogee.

In some implementations, for at least one of the subrogation demands that has not been fulfilled, is not a personal injury protection claim, and is found to be a proper subrogation demand, the method may comprise automatically initiating recovery of all or a portion of a payment amount of the insurance claim from the third party.

In some implementations, the method may comprise storing, at the data store of the database, one or more subrogation rules; and updating the data store based on changes to the one or more subrogation rules.

The subrogation demand may be determined to be improper if the insurance claim is a personal injury protection claim for a commercial vehicle having an unladen gross vehicle weight below a weight specified by the subrogation rule. In such a case, the method may comprise generating a recommendation to initiate recovery of the settlement payment amount of the subrogation demand from the subrogee.

The subrogation demand may be determined to be improper if the insurance claim is a personal injury protection claim for a multiple vehicle event involving a motorcycle and the subrogation demand should have been prorated. In such a case, the method may comprise generating a recommendation to initiate recovery of at least a portion of the settlement payment amount of the subrogation demand from the subrogee.

The subrogation demand may be determined to be improper if the insurance claim is not a personal injury protection claim but involved multiple tortfeasors and the insurance claim does not render voluntary payments non-recoverable. In such a case, the method may comprise generating a recommendation to initiate recovery of at least a portion of the settlement payment amount of the subrogation demand from the subrogee.

The subrogation demand may be determined to be improper if the insurance claim is not a personal injury protection claim and was issued by a member of Arbitration Forums. In such a case, the method may comprise generating a recommendation to file for arbitration with Arbitration Forums.

The subrogation demand may be determined to be improper if the insurance claim is not a personal injury protection claim and was not issued by a member of Arbitration Forums. In such a case, the method may comprise generating a recommendation to initiate a litigation for recovery of a settlement payment of the subrogation demand.

The present disclosure also provides a system for identifying and initiating reversible subrogation claims. The system comprises a processor; and a memory storing computer-readable instructions that, when executed by the processor, cause the processor to trigger execution of a reversible subrogation assistant. In some implementations, the system further includes a database having a data store comprising jurisdictional statutes for subrogation of insurance claims.

The reversible subrogation assistant may include an input module configured to receive a list of subrogation demands, wherein the list comprises at least one subrogation demand that has been fulfilled, and determine, by analysis of the at least one subrogation demand, a type of insurance claim of the subrogation demand, and a jurisdiction of the insurance claim; a rules module configured to access a database comprising jurisdictional statutes for subrogation of insurance claims and determine a relevant subrogation rule based on the type of the insurance claim and the jurisdiction of the insurance claim; and a validation module configured to determine if the subrogation demand is proper or improper based on an analysis of the relevant subrogation rule.

The reversible subrogation assistant may include a reversal module configured to automatically initiate recovery of all or a portion of a settlement payment for each subrogation demand determined to be improper.

The reversible subrogation assistant may include an output module configured to output an indication that the subrogation demand is proper or improper based on the analysis of the subrogation rule.

The reversible subrogation assistant may include a fulfillment module configured to automatically initiate collection of all or a portion of a settlement payment from a third party for any subrogation demand that is unfulfilled and determined to be proper.

The reversible subrogation assistant may include an update module configured to update the data store based on changes to the one or more subrogation rules.

Aspects of the invention have been discussed hereinabove as used in connection with automobile insurance. One of skill in the art will readily recognize how to adapt the methodology described above to a variety of areas of insurance, such as homeowner's insurance, and other types of insurance as mentioned hereinabove.

Various embodiments of the present disclosure may be implemented in a data processing system suitable for storing and/or executing program code that includes at least one processor coupled directly or indirectly to memory elements through a system bus. The memory elements include, for instance, local memory employed during actual execution of the program code, bulk storage, and cache memory which provide temporary storage of at least some program code to reduce the number of times code must be retrieved from bulk storage during execution.

I/O devices (including, but not limited to, keyboards, displays, pointing devices, DASD, tape, CDs, DVDs, thumb drives and other memory media, etc.) may be coupled to the system either directly or through intervening I/O controllers. Network adapters may also be coupled to the system to enable the data processing system to become coupled to other data processing systems or remote printers or storage devices through intervening private or public networks. Modems, cable modems, and Ethernet cards may be just a few of the available types of network adapters.

The present disclosure may be embodied in a system, a method, and/or a computer program product. The computer program product may include a computer readable storage medium (or media) having computer readable program instructions thereon for causing a processor to carry out aspects of the present disclosure. The computer readable storage medium may be a tangible device that may retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing.

Computer readable program instructions described herein may be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages.

A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, among others.

The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, to perform aspects of the present disclosure.

All documents cited herein may be incorporated herein by reference, but only to the extent that the incorporated material does not conflict with existing definitions, statements, or other documents set forth herein. To the extent that any meaning or definition of a term in this document conflicts with any meaning or definition of the same term in a document incorporated by reference, the meaning or definition assigned to that term in this document shall govern. The citation of any document is not to be construed as an admission that it is prior art with respect to this application.

While particular embodiments have been illustrated and described, it would be obvious to those skilled in the art that various other changes and modifications may be made without departing from the spirit and scope of the invention. Those skilled in the art will recognize or be able to ascertain using no more than routine experimentation, numerous equivalents to the specific apparatuses and methods described herein, including alternatives, variants, additions, deletions, modifications, and substitutions. This application including the appended claims is therefore intended to cover all such changes and modifications that may be within the scope of this application.

What is claimed is:

1. A computer-implemented method of identifying reversible subrogation claims, the method comprising, via one or more processors, servers, and/or associated transceivers:
receiving electronic data comprising a list including at least one subrogation demand for which a settlement payment has been made, each subrogation demand in the list being for an insurance claim,
determining, by analysis of the insurance claim of each of the subrogation demands in the list, a type of the insurance claim and a jurisdiction of the insurance claim,
determining, by accessing data stored on a database, a relevant subrogation rule for the insurance claim of each of the subrogation demands in the list based on the type of the insurance claim and the jurisdiction of the insurance claim, wherein the data stored on the database comprises jurisdictional statutes for subrogation of insurance claims,
determining if each of the subrogation demands in the list was proper or improper based on an analysis of the relevant subrogation rule, and
outputting, for each of the subrogation demands in the list, an indication that the subrogation demand was proper or improper based on the analysis of the relevant subrogation rule.

2. The method of claim 1, comprising:
storing, at the data store of the database, one or more subrogation rules; and
updating the data store based on changes to the one or more subrogation rules.

3. The method of claim 1, wherein the type of the insurance claim comprises a claim against one or more of health insurance, worker compensation insurance, liability insurance, homeowner's insurance, travel insurance, property and casualty insurance, property insurance, motorized vehicle insurance, or disability care insurance.

4. The method of claim 1, wherein the list includes, for each subrogation demand, subrogation demand information comprising a subrogee identity, the type of the insurance claim, the jurisdiction of the insurance claim, a loss amount, and a settlement payment amount.

5. The method of claim 4, wherein the method further comprises, for at least one of the subrogation demands indicated to be improper and having been fulfilled:
automatically initiating recovery of all or a portion of the settlement payment amount of the subrogation demand from the subrogee.

6. The method of claim 1, wherein the list includes at least one subrogation demand that has not been fulfilled by a third party, and upon determining the type of insurance claim is not a personal injury protection claim and the subrogation demand is proper, the method comprises: automatically initiating recovery of all or a portion of a payment amount of the insurance claim from the third party.

7. The method of claim 4, wherein the subrogation demand is determined to be improper if the insurance claim is a personal injury protection claim for a commercial vehicle having an unladen gross vehicle weight below a weight specified by the subrogation rule, wherein the method further comprises: generating a recommendation to initiate recovery of the settlement payment amount of the subrogation demand from the subrogee.

8. The method of claim 4, wherein the subrogation demand is determined to be improper if the insurance claim is a personal injury protection claim for a multiple vehicle event involving a motorcycle and the subrogation demand should have been prorated, wherein the method further comprises: generating a recommendation to initiate recovery of at least a portion of the settlement payment amount of the subrogation demand from the subrogee.

9. The method of claim 4, wherein the subrogation demand is determined to be improper if the insurance claim is not a personal injury protection claim but involved multiple tortfeasors and the insurance claim does not render voluntary payments non-recoverable, wherein the method further comprises: generating a recommendation to initiate recovery of at least a portion of the settlement payment amount of the subrogation demand from the subrogee.

10. The method of claim 1, wherein the subrogation demand is determined to be improper if the insurance claim is not a personal injury protection claim and was issued by a member of Arbitration Forums, wherein the method further comprises: generating a recommendation to file for arbitration with Arbitration Forums.

11. The method of claim 1, wherein the subrogation demand is determined to be improper if the insurance claim is not a personal injury protection claim and was not issued by a member of Arbitration Forums, wherein the method further comprises: generating a recommendation to initiate a litigation for recovery of a settlement payment of the subrogation demand.

12. A computer-implemented method of identifying reversible subrogation claims, the method comprising, via one or more processors, servers, and/or associated transceivers:
receiving electronic data comprising a list of subrogation demands comprising at least one subrogation demand for an insurance claim for which a settlement payment has been made,
determining, by analysis of the insurance claim of each of the subrogation demands in the list, a type of the insurance claim and a jurisdiction of the insurance claim,
determining, by accessing data stored on a database, a relevant subrogation rule for the insurance claim of each of the subrogation demands in the list based on the type of the insurance claim and the jurisdiction of the insurance claim, wherein the data stored on the database comprises jurisdictional statutes for subrogation of insurance claims,
determining if each of the subrogation demand was proper or improper based on an analysis of the relevant subrogation rule for the insurance claim of each of the subrogation demands in the list; and
outputting, for each of the subrogation demands in the list, an indication that the subrogation demand was proper or improper based on the analysis of the relevant subrogation rule,
wherein the subrogation demand is determined to be improper if the insurance claim comprises:
(a) a personal injury protection claim for a commercial vehicle having an unladen gross vehicle weight below a weight specified by the subrogation rule, wherein the method further comprises: generating a recommendation to initiate recovery of the settlement payment of the subrogation demand,
(b) a personal injury protection claim for a multiple vehicle event involving a motorcycle and the subrogation demand should have been prorated, wherein the method further comprises: generating a recommendation to initiate recovery of at least a portion of the settlement payment of the subrogation demand,
(c) not a personal injury protection claim but involved multiple tortfeasors and the insurance claim does not render voluntary payments non-recoverable, wherein the method further comprises: generating a recommendation to initiate recovery of at least a portion of the settlement payment of the subrogation demand,
(d) not a personal injury protection claim and was issued by a member of Arbitration Forums, wherein the method further comprises: generating a recommendation to file for arbitration with Arbitration Forums, or
(e) not a personal injury protection claim and was not issued by a member of Arbitration Forums, wherein the method further comprises: generating a recommendation to initiate a litigation for recovery of the subrogation demand.

13. The method of claim 12, wherein the list of subrogation demands includes, for each subrogation demand, a subrogee identity, the type of insurance claim, the jurisdiction of the insurance claim, a loss amount, and a settlement payment amount.

14. The method of claim 13, wherein the method further comprises, for at least one of the subrogation demands indicated to be improper:
automatically initiating recovery of all or a portion of the settlement payment amount of the subrogation demand from the subrogee.

15. The method of claim 12, wherein the list of subrogation demands comprises at least one subrogation demand that has not been fulfilled by a third party, and upon determining the type of insurance claim is not a personal injury protection claim and the unfulfilled subrogation demand is proper, the method comprises:
generating a recommendation to pursue proactive subrogation from the third party for the insurance claim of the at least one subrogation demand that has not been fulfilled.

16. The method of claim 12, comprising:
storing, at the data store of the database, one or more subrogation rules; and
updating the data store based on changes to the one or more subrogation rules.

17. A system for identifying and initiating reversible subrogation claims, the system comprising:
a processor; and
a memory storing computer-readable instructions that, when executed by the processor, cause the processor to trigger execution of a reversible subrogation assistant, wherein the reversible subrogation assistant comprises:
an input module configured to receive a list of subrogation demands, wherein the list comprises at least one subrogation demand that has been fulfilled, and determine, by analysis of the at least one subrogation demand, a type of insurance claim of the subrogation demand, and a jurisdiction of the insurance claim;
a rules module configured to access a database comprising jurisdictional statutes for subrogation of insurance claims and determine a relevant subrogation rule based on the type of the insurance claim and the jurisdiction of the insurance claim; and
a validation module configured to determine if the subrogation demand is proper or improper based on an analysis of the relevant subrogation rule.

18. The system of claim 18, comprising a reversal module configured to automatically initiate recovery of all or a portion of a settlement payment for each subrogation demand determined to be improper.

19. The system of claim 18, comprising an output module configured to output an indication that the subrogation demand is proper or improper based on the analysis of the subrogation rule.

20. The system of claim 18, wherein the list of subrogation demands received by the input module comprises at least one subrogation demand that has not been fulfilled, and the system comprises a fulfillment module configured to automatically initiate collection of all or a portion of a settlement payment of the subrogation demand from a third party.

21. The system of claim 18, comprising a database including a data store comprising jurisdictional statutes for subrogation of insurance claims, wherein the system comprises an update module configured to update the data store based on changes to the one or more subrogation rules.
